(19) United States
(12) Patent Application Publication
(10) Pub. No.: US 2026/0030075 A1
(43) Pub. Date: Jan. 29, 2026

(54) FLUID ORCHESTRATION OF MULTI-USER CONTENT GENERATION IN A MOBILE COMPUTING ENVIRONMENT

(71) Applicant: INTERNATIONAL BUSINESS MACHINES CORPORATION, Armonk, NY (US)

(72) Inventors: Alecio Pedro Delazari Binotto, Munich (DE); Jose Luis Spagnuolo Sobrinho, Alpharetta, GA (US); Fernando Luiz Koch, Palm Beach Gardens, FL (US); Francis Powlesland, München (DE)

(21) Appl. No.: 18/783,119

(22) Filed: Jul. 24, 2024

(51) Int. Cl. G06F 9/50

(52) U.S. Cl. CPC G06F 9/5083; G06F 2209/509

(57) ABSTRACT

Orchestrating multi-user content generation includes generating metrics based, at least in part, on a plurality of demands for content, a context of a mobile computing environment, sensor data for the mobile computing environment and a plurality of users within the mobile computing environment, and operating states of a plurality of generative artificial intelligence (AI) computing systems. An offloading strategy that defines which demands of the plurality of demands are to be performed by different ones of the plurality of generative AI computing systems is generated based on the metrics. The plurality of demands are distributed to one or more selected generative AI computing systems selected from the plurality of generative AI computing systems based on the offloading strategy. Content generated by the one or more selected generative AI computing systems is provided to devices corresponding to the plurality of users.

### BACKGROUND

This disclosure relates to orchestrating multi-user content generation in a mobile computing environment.

There are many different situations in which computer systems respond to demands for content from multiple users. Such situations arise in large venues such as sporting events, convention centers, transportation hubs such as airports, railway stations, bus stations, as well as certain mobile computing environments. An example of a mobile computing environment is a multi-passenger vehicle such as an automobile, a commercial aircraft (e.g., a plane and/or jet airplane), a bus, a train, or the like. In each of these environments, users often consume significant quantities of content whether the content is instructional, safety related, or for purposes entertainment. Providing this content requires significant computational resources for both playback and delivery to the devices used by the end users.

In the typical case, the content provided to users in these environments is largely static in nature. That is, the content requested and played is premade or pre-generated. For example, the content may be pre-made movies or television shows, pre-recorded songs, books, and the like. More and more users, however, are consuming dynamically generated content. Dynamically generated content refers to content that is created or generated using generative artificial intelligence (AI) technology. The generation and delivery of this type of content requires even greater computational resources than delivering static content. When mobile computing environments are considered, the challenges of providing dynamically generated content to users within such environments become even greater.

### SUMMARY

In one or more embodiments, a method includes generating metrics based, at least in part, on a plurality of demands for content, a context of a mobile computing environment, sensor data for the mobile computing environment and a plurality of users within the mobile computing environment, and operating states of a plurality of generative artificial intelligence (AI) computing systems. The method includes generating an offloading strategy defining which demands of the plurality of demands are to be performed by different ones of the plurality of generative AI computing systems based on the metrics. The method includes distributing the plurality of demands to one or more selected generative AI computing systems selected from the plurality of generative AI computing systems based on the offloading strategy. The method includes providing content generated by the one or more selected generative AI computing systems to devices corresponding to the plurality of users.

In one or more embodiments, a system includes a hardware processor or other computer hardware capable of performing executable operations. The executable operations include generating metrics based, at least in part, on a plurality of demands for content, a context of a mobile computing environment, sensor data for the mobile computing environment and a plurality of users within the mobile computing environment, and operating states of a plurality of generative AI computing systems. The executable operations include generating an offloading strategy defining which demands of the plurality of demands are to be performed by different ones of the plurality of generative AI computing systems based on the metrics. The executable operations include distributing the plurality of demands to one or more selected generative AI computing systems selected from the plurality of generative AI computing systems based on the offloading strategy. The executable operations include providing content generated by the one or more selected generative AI computing systems to devices corresponding to the plurality of users.

In one or more embodiments, a computer program product includes a computer readable storage medium having program instructions stored thereon. The program instructions are executable by a hardware processor, e.g., computer hardware, to cause the hardware processor to execute operations. The executable operations include generating metrics based, at least in part, on a plurality of demands for content, a context of a mobile computing environment, sensor data for the mobile computing environment and a plurality of users within the mobile computing environment, and operating states of a plurality of generative AI computing systems. The executable operations include generating an offloading strategy defining which demands of the plurality of demands are to be performed by different ones of the plurality of generative AI computing systems based on the metrics. The executable operations include distributing the plurality of demands to one or more selected generative AI computing systems selected from the plurality of generative AI computing systems based on the offloading strategy. The executable operations include providing content generated by the one or more selected generative AI computing systems to devices corresponding to the plurality of users.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates a computing environment in accordance with one or more embodiments of the disclosed technology.

FIG. 2 illustrates certain operative features of a mobile computing environment in accordance with one or more embodiments of the disclosed technology.

FIG. 3 illustrates a method of certain operative features of the sensor data processor of FIG. 2 in accordance with one or more embodiments of the disclosed technology.

FIG. 4 illustrates a method of certain operative features of the orchestration engine of FIG. 2 in accordance with one or more embodiments of the disclosed technology.

FIG. 5 illustrates a method of certain operative features of the offloading engine of FIG. 2 in accordance with one or more embodiments of the disclosed technology.

FIGS. 6A and 6B, taken collectively, illustrate a method of certain operative features of the local generative artificial intelligence computing system in accordance with one or more embodiments of the disclosed technology.

### DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to orchestrating multi-user content generation in a mobile computing environment. More particularly, the disclosure relates to a sensor-driven approach to the orchestration of multi-user content generation in such environments. In accordance with the inventive arrangements disclosed herein, methods, systems, and computer-program products are provided that are capable of addressing real-world demand for dynamic content generation in multi-user, mobile computing environments. The inventive arrangements are capable of seamlessly orchestrating the use and operation of generative artificial intelligence (AI) computing system(s) that are local to the mobile computing environment with one or more other generative AI computing systems that are remote from, e.g., not local to, the mobile computing environment. By orchestrating the use and operation of these different types of generative AI computing systems, the content generation demands of multiple users may be met. Moreover, the content generation demands may be met in a seamless manner that accounts for availability of hardware resources, availability of generative AI models, as well as contextual information relating to the mobile computing device itself and the users within the mobile computing environment.

According to an aspect of the inventive arrangements, there is provided a method for fluid orchestration of multi-user content generation in a mobile computing environment. The method includes generating metrics based, at least in part, on a plurality of demands for content, a context of a mobile computing environment, sensor data for the mobile computing environment and a plurality of users within the mobile computing environment, and operating states of a plurality of generative AI computing systems. The method includes generating an offloading strategy defining which demands of the plurality of demands are to be performed by different ones of the plurality of generative AI computing systems based on the metrics. The method includes distributing the plurality of demands to one or more selected generative AI computing systems selected from the plurality of generative AI computing systems based on the offloading strategy. The method includes providing content generated by the one or more selected generative AI computing systems to devices corresponding to the plurality of users.

A technical effect is that the workload involved in generating content in response to a plurality of demands in a mobile computing environment is apportioned among different generative AI computing systems. This enables the demands to be fulfilled in a seamless manner that utilizes the computing capacity of a local generative AI computing system of the mobile computing environment while also not overloading that system. Demands are directed to the particular generative AI computing systems suited to handle such demands, whether by virtue of available hardware computing resources and/or the generative AI models executed by such system(s). The generation of the offloading schedule accounts for real-world conditions including the changing location of the mobility of the mobile computing environment relative to different generative AI computing systems, changing demands from the users of that mobile computing environment while in motion, and network conditions linking the various computing nodes in communication with one another.

In some aspects, the techniques described herein relate to a method that includes receiving one or more of the plurality of demands from one or more of the plurality of users. A technical effect includes the ability for the system to react to actual requests originating from users in changing circumstances of the mobile computing environment to better manage usage of a local (e.g., first) generative AI computing system (e.g., local computing resources).

In some aspects, the techniques described herein relate to a method that includes automatically generating one or more of the plurality of demands based, at least in part, on the context of the mobile computing environment and the sensor data. A technical effect includes the system automatically initiating the generation of content for and/or on behalf of a user based changing circumstances of the mobile computing environment. Automated generation of demands may anticipate later demands of users and obviate the need for such demands, which helps in workload distribution.

In some aspects, the automatically generating the one or more of the plurality of demands is based, at least in part, on a point of interest along a route of the mobile computing environment. A technical effect includes the ability to generate content, as requested by the automatically generated demand(s), that is timely and relevant to the real-world route and/or motion of the mobile computing environment. The automatic generation of content, whether based on sensor data, context, and/or point(s) of interest are also predictive in nature and anticipate future requests. The automated generation demands effectively initiates the generation of content without waiting for user's to explicitly submit demands. This allows the system to better manage workloads, e.g., perform load balancing, relating to content generation and possible offloading of the workloads (e.g., demands).

In some aspects, the techniques described herein relate to a method, wherein the mobile computing environment is a vehicle. A technical effect includes a vehicle having the capability of managing workloads for content generation with respect to a local generative AI computing system and/or remote generative AI computing systems to deliver content and seamlessly service demands of users (e.g., passengers) of that vehicle. That is, the vehicle itself may manage the offloading in a mobile context to adapt to changing circumstances while the vehicle is in motion.

In some aspects, the techniques described herein relate to a method, wherein the vehicle is in motion along a predetermined route. A technical effect includes generating demands in anticipation of points of interest along the predetermined route. Demands may be generated prior to reaching a point of interest to avoid systems being overloaded with a large number of demands for content at or about the same time. The automated generation of content facilitates load balancing.

In some aspects, the plurality of generative AI computing systems includes a first generative AI computing system local to the mobile computing environment and a second generative AI computing system that is remotely located from the mobile computing environment. A technical effect includes more efficient utilization of the computing resources of the first generative AI computing system (e.g., the local GAICS) and of any remote generative AI computing systems. Demands that may be serviced by remote generative AI computing systems may be offloaded as such to avoid overload of the local computing resources of the mobile computing environment.

In some aspects, the techniques described herein relate to a method, wherein the offloading strategy is generated based, at least in part, on a distance between the second generative AI computing systems and the mobile computing environment. A technical effect includes avoiding conditions in which a response from the second generative AI computing system is untimely or late owing to the distance and/or other conditions such as network congestion between the mobile computing environment and the second generative AI computing system.

In some aspects, the techniques described herein relate to a method, wherein the offloading strategy is generated based, at least in part, on an estimated response time for receiving content from the second generative AI computing system. A technical effect includes avoiding offloading a demand to a remote generative AI computing system in cases where the remote generative AI computing system is unlikely to generate content and provide that content in a timely manner. A technical effect includes avoiding any further overload of the remote generative AI computing system in cases where that system is unlikely to respond in the required amount of time and providing the demand to another such system or handling the demand locally.

In some aspects, the techniques described herein relate to a method, wherein the offloading strategy is generated based, at least in part, on available computing capacity of the first generative AI computing system and an availability of one or more generative AI models on the first generative AI computing system required for generating content in response to one or more of the plurality of demands. A technical effect includes ensuring that a demand provided to a given generative AI computing system is handled in a timely manner and not dropped and that the particular generative AI models needed to execute the demand are available on the generative AI computing system. Were the generative AI computing system to be overloaded or lack the necessary generative AI model(s), the demand may be dropped.

In some aspects, the method includes unloading an AI model from the first generative AI computing system and loading a different AI model in the first generative AI computing system based on one or more of the plurality of demands. A technical effect includes improved management of computational resources of the local AI computing system of the mobile computing environment. Those generative AI models that are not needed to service demands may be unloaded thereby freeing computational resources to load other generative AI models that are needed to service demands handled locally.

In some aspects, the techniques described herein relate to a method including configuring an AI model executed by the first generative AI computing system based on one or more of the plurality of demands. A technical effect includes improved management of computational resources. For example, configuring a generative AI model may allow the model to complete inference tasks (e.g., content generation) faster or using fewer computation resources in cases where computational resources are strained, take more time for improved quality of content generation in cases where computational resources are not strained, or better personalize the content that is generated to particular users and/or groups. Improved content generation (e.g., personalization through configuration) improves resource utilization in that the number of demands to be serviced may remain low as opposed to users receiving content of less interest that only results in users submitting more demands for alternative content.

Further aspects of the embodiments described within this disclosure are described in greater detail with reference to the figures below. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

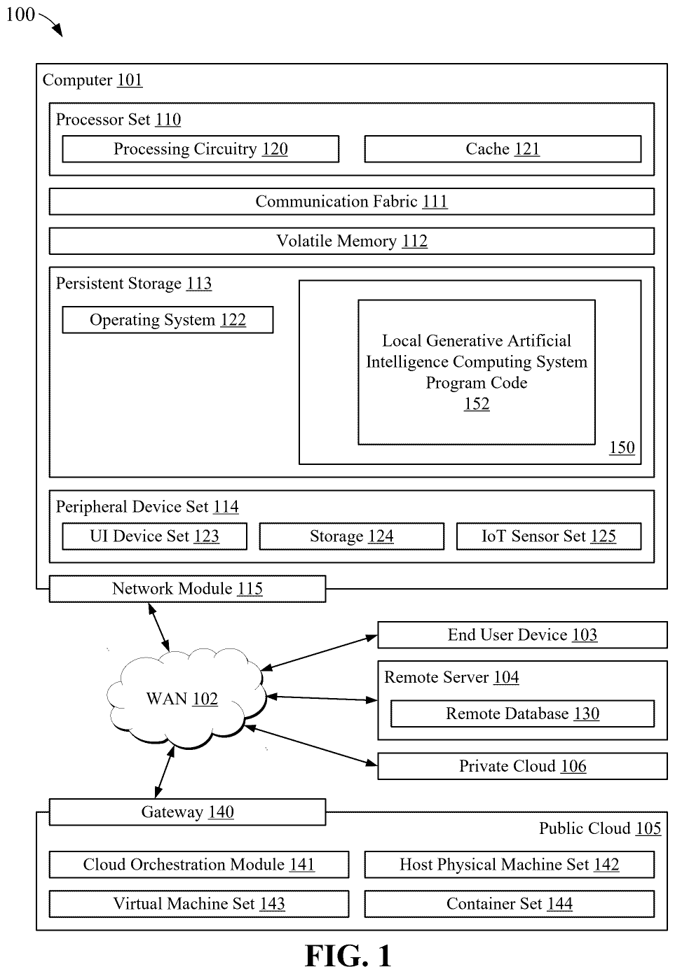

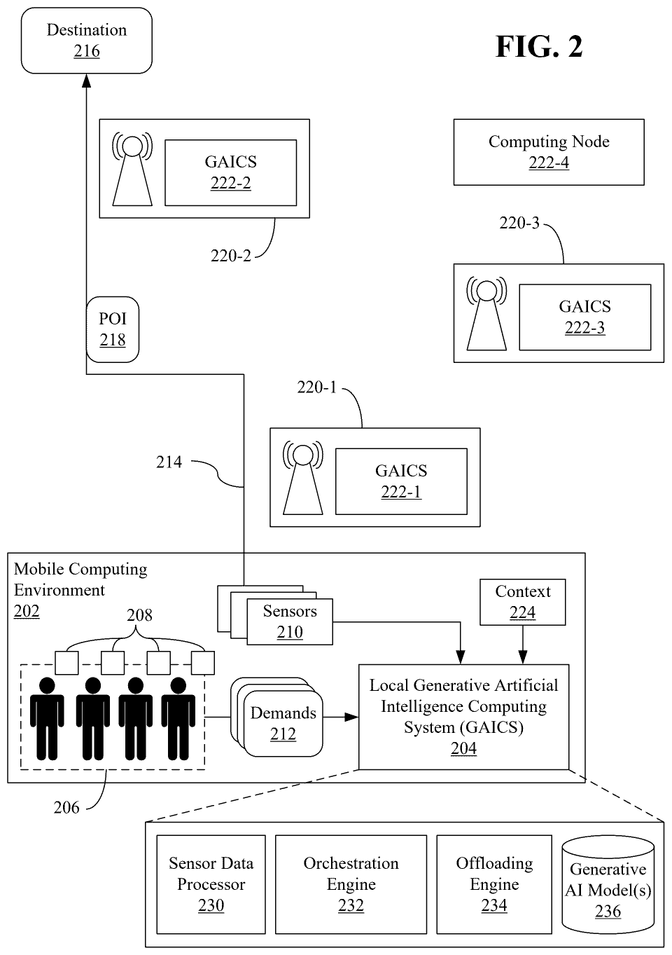

FIG. 1 illustrates a computing environment 100 in accordance with one or more embodiments of the disclosed technology. Computing environment 100 contains an example of an environment for the execution of at least some of the computer code in block 150 involved in performing the inventive methods. Block 150, for example, includes program code that is executable to perform methods relating to fluid orchestration of multi-user content generation in a mobile computing environment. As illustrated, block 150 includes local generative AI computing system (GAICS) program code 152, which may be executed by a local GAICS 204 described in greater detail in connection with FIG. 2. In one or more embodiments, local GAICS 204 may be implemented as computer 101 of FIG. 1. Local GAICS 204 may be included in a mobile computing environment 202 also described in connection with FIG. 2.

In general, local GAICS 204 is capable of determining a plurality of demands for content based, at least in part, on a context of mobile computing environment 202, and sensor data for mobile computing environment 202 and a plurality of users within mobile computing environment 202. Local GAICS 204 also is capable of detecting computing requirements of the plurality of demands. Local GAICS 204 is capable of generating an offloading strategy defining which demands of the plurality of demands are to be performed by different ones of a plurality of generative AI computing systems based on the context of the mobile computing environment, the sensor data, and the computing requirements. For example, local GAICS 204 is capable of allocating the plurality of demands to one or more selected generative AI computing systems. Local GAICS 204 also is capable of providing the content as generated by the selected one or more generative AI computing systems to the plurality of users.

In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

FIG. 2 illustrates certain operative features of mobile computing environment 202 in accordance with one or more embodiments of the disclosed technology. Mobile computing environment 202 may be implemented as a multi-passenger vehicle. Examples of multi-passenger vehicles may include, but are not limited to, an automobile, a truck, a van, a bus, an aircraft such as a helicopter, an airplane, a jet airplane, an orbital/space vehicle, trolley, a train, cable car, or the like. Mobile computing environment 202 may be a personally owned vehicle, a privately owned vehicle, or a public (e.g., public transit) vehicle.

As illustrated, mobile computing environment 202 is capable of carrying one or more, e.g., a plurality, of users 206. Users 206, for example, may be passengers. In some cases, users 206 are capable of moving about within mobile computing environment 202 while in other cases, depending on the particular implementation of mobile computing environment 202, users 206 may remain relatively immobile or stationary within mobile computing environment 202.

In the example of FIG. 2, users 206 may have, or be capable of operating, devices 208. In one or more embodiments, one or more or all of devices 208 are personal computing devices such as a smart phone, a wearable computing device, portable computer such as a laptop or tablet, or other type of computing device that is capable of communicating with local GAICS 204. For example, one or more of devices 208 may be implemented as an end user device such as EUD 103 of FIG. 1. In some embodiments, users 206 may opt into sharing data from their devices, whether the data being shared is selected state data from their respective devices, sensor data generated by their respective devices, explicit feedback (e.g., user responses), user profile data, or other user inputs. In one or more other embodiments, one or more of devices 208 may be a terminal that is provided by or part of mobile computing environment 202 and that is usable or shared by one or more users 206 whether concurrently or at different times. For example, one or more of devices 208 may be a terminal capable of receiving user input and providing generated content (e.g., text, images, video, and or audio). Examples of such devices may include an entertainment system or terminal in a headrest of a seat in an automobile or airplane, a shared display screen, etc. In such cases, the devices may be operatively coupled to local GAICS 204.

Mobile computing environment 202 also includes one or more, e.g., a plurality of, sensors 210. In one or more embodiments, sensors 210 may include one or more IoT sensors of sensor set 125 described in connection with FIG. 1. In one or more embodiments, sensors 210 may include other types of sensors including, but not limited to, cameras, microphones, temperature sensors, motion sensors, a global positioning system, accelerometers, gyroscopes, and the like.

Sensors 210 are capable of collecting and outputting a variety of different types of information. For example, sensors 210 are capable of capturing individual and collective information for users 206, tracking location (e.g., movement) of users 206 within mobile computing environment 202, tracking the location (e.g., movement) of mobile computing environment 202, and/or detecting environmental conditions. The environmental conditions may include environmental conditions within mobile computing environment 202 (e.g., temperature) and environmental conditions external to mobile computing environment 202 (e.g., temperature, precipitation, wind speed and/or direction, etc.).

In the example, users 206 may submit demands 212 to local GAICS 204. Each demand may be a particular request for generative content. A demand may be specified as structured data or as free-form data. The demands may be, for example, in text form, speech recognized text, or the like. In one or more embodiments, users 206 may submit demands 212 using their respective devices 208 that may be in wired and/or wireless communication with local GAICS 204. In some embodiments, one or more of demands 212 are “explicit” demands which may be user queries or requests for content directed to local GAICS 204. In one or more other embodiments, one or more demands may be automatically generated by local GAICS 204. For example, because a user chooses to share computing data from their device 208, based on sensor data, and/or based on a context of mobile computing environment 202 described below, local GAICS 204 may detect that the user is conducting a particular Web search, reading particular content (e.g., a book, a Web page, etc.), listening to particular content, and/or viewing particular audiovisual content (e.g., a video). Local GAICS 204 may interpret the data willingly shared from the user's device, sensor data, and/or context of mobile computing environment 202 to formulate or generate one or more demands for content. The demands for content generated may be for personalized content. The demands may be for content of the same or similar variety to that which the user is currently consuming on their device, content about the context of mobile computing environment 202, and/or content pertaining to the context of the mobile computing environment as informed by (e.g., based on) the sensor data. In such cases, local GAICS 204 is capable of generating one or more demands for such content on behalf of one or more users 206.

In one or more embodiments, mobile computing environment 202 may have a known or predetermined context 224. Context 224 may define a particular purpose (e.g., a goal or objective) of mobile computing environment 202 and/or users 206 in mobile computing environment 202. An example context for mobile computing environment 202 may be a tour (e.g., a tourism tour where mobile computing environment 202 is a tour bus or other vehicle traversing a known, predetermined, or predictable route), one or more of users 206 going to work or embarking on a trip, etc. In some cases, the context of mobile computing environment 202 may specify a known destination and, as such, have a predictable route. Context 224 may specify a particular mode of transportation such as driving, walking, bus, or train. Context 224 of mobile computing environment 202 also may specify a number of users 206 in mobile computing environment 202. The number of users may be determined by detecting the users 206 via sensors 210, by each user indicating presence within mobile computing environment 202, or via user input to local GAICS 204. Context 224 further may specify a relationship between users 206 or between subsets of users 206. For example, depending on the context (e.g., business trip, going to work, vacation, etc.) the users 206 may not be acquainted, may be colleagues, may be family (e.g., related), etc.

In the example of FIG. 2, for purposes of illustration, mobile computing environment 202 may be in motion and traversing a predetermined or known route 214. Route 214 may have a predetermined or known destination 216. As an illustrative and nonlimiting example, destination 216 may be a particular end point or point of interest (POI) as part of an organized tour, a location specified by one of users 206 as part of a request for directions, a stop on a bus or train route, a destination airport, landmark, or the like. There may also be one or more other POIs 218 (e.g., locations, landmarks, structures, etc.) located on, along, or within a predetermined distance of route 214.

FIG. 2 also illustrates that there may be one or more other computing nodes 220 shown as computing nodes 220-1, 220-2, 220-3, and 220-4 dispersed geographically. That is, computing nodes 220-1, 220-2, 220-3, and 220-4 are disposed at different locations and are considered remotely located from mobile computing environment 202. Each of computing nodes 220 may be accessed by a communication link, e.g., a wireless communication link such that mobile computing environment 202 and/or user devices 208 therein may communicate with computing nodes 220. Each of computing nodes 220-1, 220-2, and 220-3 further includes a respective GAICS 222-1, 222-2, and 222-3 that may be accessed by establishing a communication link with the respective computing node 220. In the example, computing node 220-4 may be a cloud computing node (e.g., a data center).

In one or more embodiments, one or more of computing nodes 220 may be implemented as a remote server such as remote server 104 of FIG. 1. In one or more embodiments, one or more of computing nodes 220 may be implemented as a private cloud such as private cloud 106 of FIG. 1. In one or more embodiments, one or more of computing nodes 220 may be implemented as a public cloud such as public cloud 105 of FIG. 1.

In one or more embodiments, one or more of computing nodes 220 is implemented as a multi-access edge computing (MEC) node. MEC is a European Telecommunications Standards Institute (ETSI)-defined network architecture. The network architecture facilitates the implementation of cloud computing capabilities and an Information Technology (IT) service environment at edge nodes of a cellular and/or other type of network. Accordingly, computing nodes 220 implemented as MEC nodes are capable of providing cloud computing capabilities and may host or execute any of a variety of generative AI models. Accordingly, each of computing nodes 220 is capable of performing on-demand inference (e.g., performing generative AI tasks or operations) in response to demands received from local GAICS 204.

Local GAICS 204 may be implemented as an onboarded, e.g., in vehicle, computing system that is capable of dynamically generating content for users 206 based on a set of demands whether from users 206, automatically generated, or a combination thereof. Local GAICS 204 may include computing clusters, a repository of base methods to perform the operations described herein and/or foundational models (e.g., generative AI models and/or other AI models). In the example, local GAICS 204 may be embodied as one or more hardware processors (e.g., CPUs and/or GPUs and memory) that are integrated in mobile computing environment 202 and/or as a dedicated computing system in mobile computing environment 202. Such computing hardware, for example, may be part of an infotainment system of mobile computing environment 202.

In the example of FIG. 2, local GAICS 204 may execute a software framework capable of performing the various operations described within this disclosure. In general, local GAICS 204 is capable of providing contextualized and/or personalized content to users 206 as a service. Local GAICS 204 further is capable of connecting to generative AI models executing at one or more of computing nodes 220. In the example, the executable framework includes a sensor data processor 230, an orchestration engine 232, an offloading engine 234, and one or more generative AI models 236 that are considered local generative AI models with respect to local GAICS 204 and mobile computing environment 202.

Sensor data processor 230 is capable of pre-processing sensor data received from sensors 210. For example, sensors 210 may not produce data in a uniform way. Some sensors 210 may output binary data while others output JSON data structures, or the like. The type of output from sensors 210 may vary based on the type of sensor and/or sensor manufacturer/provider. In the example, sensor data processor 230 is capable of capturing data from sensors 210 and formatting the sensor data in a uniform manner that may be consumed or utilized by other systems such as orchestration engine 232. This allows orchestration engine 232 to process the data and generate an understanding of what the sensor data means.

Sensor data, as output from sensor data processor 230, is capable of capturing individual user preferences, tracking user movements within mobile computing environment 202, and monitoring environmental conditions. Sensor data processor 230 is capable of continuously updating the formatted sensor data and outputting the formatted sensor data. The sensor data, as output from sensor data processor 230, may be used as input by orchestration engine 232 and/or offloading engine 234 for the offloading decision-making described herein.

In one or more embodiments, users 206 may be organized or assigned to groups. Each group may include one, two, or more users. Each group may have a group context that may be generated from the user contexts of the user(s) of the group. In that case, content may be generated for the group based, at least in part, on the group context of the group. That is, demands and/or content generation may be performed on a per-group basis as opposed to a per user basis.

Orchestration engine 232 is capable of operating on the sensor data, e.g., a corpus of such data. Orchestration engine 232 is also capable of receiving context 224 and, if provided, demands 212. In general, orchestration engine 232 is capable of executing one or more AI models trained to prioritize particular sensor data considered more relevant given context 224. That is, at a given point in time, given context 224 and the sensor data, orchestration engine 232 is capable of prioritizing and/or de-prioritizing one or more particular source(s) or stream(s) of sensor data over others for purposes of content generation. In one or more embodiments, orchestration engine 232 is capable of generating demands based on context 224 and the sensor data as prioritized.

In one or more embodiments, orchestration engine 232 is capable of calculating a variety of metrics such as computing resource availability in local GAICS 204, which generative AI models 236 are currently loaded for execution in local GAICS 204, the configuration (e.g., tuning) of generative AI models 236, mobility patterns of users 206, intentionality of collective user intention, variations of collective user behavior, and the computing requirements of demands 212. For example, mobility patterns may be specified as a city tour, a business meeting, driving (as opposed to walking), and the like. Mobility pattern(s) may be included in context 224. Collective user intention may include discovering or determining a desire of a user such as discover the history of POI 218. Variations in collective user behavior may include determining group profiles in terms of interests in content. As an example, one group of users 206 may have an interest in history while another group of 206 may be interested in restaurants. Each group may have content tailored to their own behavior.

In one or more embodiments, orchestration engine 232 is also capable of determining other metrics such as the congestion of the local network within mobile computing environment 202 to which devices 208 are connected, the congestion of network(s) through which mobile computing environment 202 communicates with one or more of computing nodes 220, the distance between mobile computing environment 202 and different ones of computing nodes 220, which generative AI models are available within different ones of computing nodes 220, and/or which of computing nodes 220 are available (e.g., capable of servicing one or more demands 212 and/or are close enough to provide real-time and/or near real-time responses given current network conditions).

Offloading engine 234 is capable of operating in cooperation with orchestration engine 232 to orchestrate the execution of demands 212 for content. In one or more embodiments, offloading engine 234 is capable of determining the complexity of demands 212. In one or more embodiments, complexity is a measure of variation in different interests of the users as measured from content requests in demands, whether the demands are from users 206, automatically generated by local GAICS 204, or are a combination of both. For example, in cases where the demands are for similar content across users and/or groups of users, the complexity is considered lower. In cases where the variation in demands across users and/or groups of users is higher, the complexity is higher. Put another way, in cases where users and/or groups of users share a same goal, complexity is lower than if the goals are not shared.

Offloading engine 234 is capable of allocating demands 212 (which may include demands received explicitly from users 206 and/or automatically generated demands) among one or more different generative AI computing systems whether local GAICS 204 and/or one or more of computing nodes 220. Offloading engine 234 is capable of distributing demands 212 to selected generative AI computing systems based on various metrics that may include, but are not limited to, the complexity of demands 212, computing resource availability given a current processing load of local GAICS 204, computing resource availability given current processing loads of one or more or all of computing nodes 220, availability of generative AI models in local GAICS 204 and/or computing nodes 220, mobility patterns of users 206, intentionality of collective movement of users 206, and/or variations of collective behavior of users 206.

In one or more embodiments, offloading engine 234 is capable of choosing which demands 212 are to be offloaded to a selected computing node 220 to compensate for a lack of local resources in local GAICS 204 while also ensuring that the demand(s) 212 that are offloaded are timely processed so that users 206 perceive responses (e.g., the generated content) to be received in real-time or near real-time in relation to demand(s) 212 and/or in a timely manner.

For example, offloading engine 234 is capable of generating an offloading strategy that specifies that all of demands 212 are to be provided to generative AI models 236 executing locally in local GAICS 204, all of demands 212 are to be provided to one or more of computing nodes 220, or one or more demands 212 are to be provided to generative AI models 236 executing locally in local GAICS 204 and one or more other ones of demands 212 to one or more computing nodes 220.

Generative AI models 236 may be implemented as any of a variety of known and/or to be developed large AI models. The AI models may be referred to as foundational models. One or more generative AI models 236 may include one or more large language models (LLMs), Generative Adversarial Networks (GANs), Diffusion Models, Variational Autoencoders (VAEs), Flow models, or the like. Different models may be trained to generate different types of content (e.g., text vs. video vs. images, etc.). For example, an LLM such as ChatGPT may be used to generate text while another AI model such as Sora AI Video Generator may be used to generate video content. Local GAICS 204 is capable of performing on-demand, local inference by executing one or more selected generative AI models 236.

In the example of FIG. 2, generative AI models 236 are pre-trained models each capable of generating certain type(s) of content and/or responding to particular type(s) of demands. In one or more embodiments, each different generative AI model 236, though trained, may be configured once loaded for execution. An example of configuring a generative AI model is tuning the generative AI model by setting and/or changing one or more hyperparameters of the generative AI model once loaded for execution (e.g., where loading includes loading the model or portions thereof into program execution memory of a computing system). In this regard, offloading engine 234 is capable of not only loading and/or unloading different ones of generative AI models 236 in response to changing demands, but also configuring and/or re-configuring those generative AI models 236 that have been loaded for execution (e.g., for performance of an inference task such as generating content).

In one or more embodiments, orchestration engine 232 is capable of controlling which generative AI models 236 are loaded for execution in local GAICS 204. Orchestration engine 232 is capable of unloading (e.g., from program execution memory) one or more selected generative AI models 236 and/or loading one or more generative AI models 236 (e.g., into program execution memory) based on new or changing demands over time.

In one or more embodiments, through the generation of demands as described herein, local GAICS 204 is capable of predicting selected content to be generated, generating the selected content automatically (e.g., either locally or by offloading automatically generated demand(s)), and providing the selected content to a device of at least one user. This may include, for example, generating content for one or more users based on the context 224, sensor data (which may include distance of mobile computing environment 202 to a POI along route 214), and/or other user data.

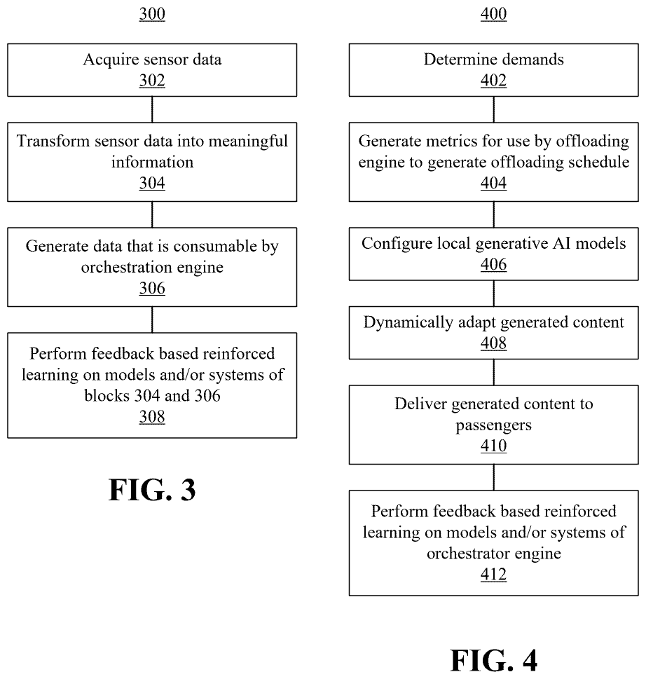

FIG. 3 illustrates a method 300 of certain operative features of sensor data processor 230 in accordance with one or more embodiments of the disclosed technology. Method 300 illustrates a process performed by sensor data processor 230 to process sensor data obtained from sensors 210 of mobile computing environment 202.

In block 302, sensor data processor 230 acquires the sensor data from sensors 210. In block 302, sensor data processor 230 is capable of capturing, e.g., storing, sensor data from the various sensors 210 of mobile computing environment 202. In addition, sensor data processor 230 is capable of storing any individual preferences of users 206 as may be provided via a device 208 as part of the sensor data that is stored. As discussed, the sensor data that is captured includes information such as user location indicating user movements over time within mobile computing environment 202, user image data, environmental conditions inside and/or outside of mobile computing environment 202, and/or operating conditions of mobile computing environment 202 itself.

In block 304, sensor data processor 230 is capable of transforming the sensor data into meaningful information. In one or more embodiments, sensor data processor 230 is capable of executing one or more AI models and/or rule-based systems that process the sensor data to generate an interpretation of the sensor data for mobile computing environment 202, for each user, and/or for different groups of users 206. The interpretations generated by sensor data processor 230 in block 304, for example, may specify environmental conditions inside and outside of mobile computing environment 202, operating state of mobile computing environment 202 itself, a current speed and/or trajectory of mobile computing environment 202, and proximity to one or more POIs and/or compute nodes 220.

As part of block 304, sensor data processor 230 is capable of determining individual preferences of users, a location of users within mobile computing environment 202, what content users 206 are currently consuming, whether users 206 appear engaged in the content (e.g., whether users 206 watched a particular item of content in its entirety or stopped at some point and did not finish consuming the content), and sentiment expressed by users. For example, speech recognition models and natural language models may be executed to process received audio of user speech to determine meaning and/or sentiment of content that may be discussed. Image processing models may be executed to detect direction of users gaze and whether users are viewing their or another device 208. Sentiment analysis may be performed on speech recognized text and/or facial features using trained sentiment analysis AI models.

In block 306, sensor data processor 230 is capable of generating data that is consumable by orchestration engine 232. For example, sensor data processor 230 is capable of executing one or more AI models or a rule-based system capable of formatting and/or compiling the information obtained from block 304. Data generated sensor data processor 230 may be output in the form of vectors, tensors, or other data structures. In embodiments where users are placed into groups, in block 306, group contexts may be generated (e.g., where data from sets of two or more users is grouped together).

In block 308, sensor data processor 230 is capable of performing feedback-based, reinforced learning on the AI models and/or rule-based systems executed in blocks 304 and 306. For example, sensor data processor 230 is capable of implementing a feedback loop that continuously refines and/or optimizes the AI models and/or rule-based systems based on the performance and effectiveness of the pre-processed sensor data. By continuously refining the AI models and/or rule-based systems, the capability of the sensor data processor 230 to accurately process the sensor data continues to improve over time.

Though method 300 is illustrated as a series of serially performed blocks, it should be appreciated that blocks of FIG. 3 may be performed continuously in real-time or near real-time such that the data generated is continuously being updated in real-time or near real-time.

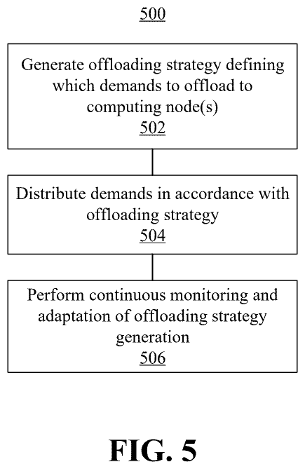

FIG. 4 illustrates a method 400 of certain operative features of orchestration engine 232 in accordance with one or more embodiments of the disclosed technology.

In block 402, orchestration engine 232 is capable of determining a plurality of demands for content. In one or more embodiments, orchestration engine 232 is capable of automatically generating one or more demands for content based, at least in part, on the context 224 of mobile computing environment 202 and sensor data from sensors 210. The sensor data 210 may be for mobile computing environment 202 and for users 206 within mobile computing environment 202. In one or more embodiments, as part of block 402, orchestration engine 232 is also capable of receiving one or more of the plurality of demands from one or more of the plurality of users (e.g., explicit request for content from users 206).

For example, with reference to automatically generating one or more of the plurality of demands, orchestration engine 232 may include a generative AI model that is trained to generate demands (e.g., requests for content such as prompts to be submitted to generative AI models requesting the generation of content). The generative AI model of orchestration engine 232 may be trained to output demands given received input such as the formatted sensor data, context 224, and/or any metrics that may be generated internally by orchestration engine 232. Such metrics, once created, may be continually fed into the generative AI model. In other embodiments, the generative AI model of orchestration engine 232 also may use data shared by users 206 from their respective devices such as content being viewed or otherwise consumed as input.

In block 404, orchestration engine 232 is capable of generating metrics for use by offloading engine 234 to generate the offloading schedule. Orchestration engine 232 is capable of providing the metrics to offloading engine 234. The metrics generated may include metrics that define or specify qualities or attributes of the demands for content (whether user provided or automatically generated) and the particular mobile AI computing systems being considered for handling the demands (e.g., local GAICS 204 and/or computing nodes 220). In this regard, the metrics are generated for, or based on, the demands for content, the context 224, sensor data for mobile computing environment 202 and/or users 206, and/or a plurality of generative AI computing systems and/or the operating states thereof.

For example, orchestration engine 232 is capable of calculating metrics including, but not limited to, complexity of demands. With respect to generative AI computing systems and/or operating states of such systems, orchestration engine 232 is capable of calculating metrics such as availability of a given computing node 220 to generate content in response to a given demand (e.g., whether mobile computing environment 202 is within the geographic service area of the computing node 220); the availability of computing resources (e.g., hardware) of the computing node 220 to handle a given demand given the computing node's 220 current workload; the availability of a generative AI model capable of responding to the demand on computing node 220; the availability of computing resources (e.g., hardware) of local GAICS 204 to handle a given demand given the current workload of local GAICS 204; the availability of a generative AI model capable of responding to the demand on local GAICS 204 and/or on computing nodes 220. With respect to sensor data, orchestration engine 232 is capable of calculating metrics such as a location of mobile computing environment 202 relative to the compute node(s) 220 (e.g., distance); network delays and/or congestion in network connecting local GAICS 204 with computing nodes 220; variations in collective behavior; POIs within predetermined distances; distance between mobile computing environment 202 and POIs; estimated time for mobile computing environment 202 to reach POIs and/or computing nodes 220 given the route, current location speed, etc.; environmental conditions as may be determined from the sensor data; and/or different combinations thereof. As noted, orchestration engine 232 also generates metrics based on information from context 224.

In one or more embodiments, the complexity of demands 212 is specified by orchestration engine 232 based on the variation across demands 212. For example, the complexity of demands may be determined, at least in part, based on the variation and/or similarity of topics of the demands and/or a target audience of the demands (e.g., based on user provided information including age, education, or the like). Complexity of demands also may be determined based on one or more templates. In one aspect, a template may specify a format or syntax for demands to be submitted to generative AI models that may be used or stored within local GAICS 204. The templates, for example, may specify a structure of prompts to be provided to generative AI models as inputs. In other cases, templates may specify methods or techniques for stitching together or connecting different generated content that may be returned from one or more generative AI models in answer to a particular demand (e.g., multiple segments of generated audio, video, etc. that may be stitched or otherwise connected or played sequentially). A template that has more segments would correspond to a demand of greater complexity than a template with fewer segments. Demands exhibiting greater complexity are more likely to be offloaded in order to seamlessly generate content in response to the demands.

With regard to computing resources, orchestration engine 232 is capable of detecting available bandwidth or capability of a computing system to generate content in response to a demand given a current workload performed by the computing system. Orchestration engine 232 is capable of tracking the workload of the local GAICS 204 on a continual or real-time basis. Orchestration engine 232 is also capable of submitting queries to computing nodes 220 for capacity, current workload measures, and/or which generative AI models are available at particular computing nodes 220.

In one or more embodiments, as part of block 404, orchestration engine 232 is capable of detecting which of generative AI models 236 are loaded (e.g., available for execution) and, given current demands 212 and/or the current workload of local GAICS 204 given the capacity of local GAICS 204 to perform workloads, the need to offload one or more of generative AI models 236 to free up computing resources to load and/or execute one or more other ones of generative AI models 236.

In block 406, orchestration engine 232 is capable of configuring one or more of the local generative AI models 236. In one or more embodiments, orchestration engine 232 includes one or more AI models and/or rule-based systems that are executable to plan and configure local generative AI models 326. In one or more embodiments, orchestration engine 232 is capable of configuring one or more of generative AI models 236 based on the metrics determined in block 404. In one or more examples, orchestration engine 232 may tune one or more generative AI models 236 to consume fewer computational resources in response to more complex demands, a number of demands exceeding a threshold number, or a rate of demands exceeding a particular threshold rate, whereby the generative AI models may generate content faster albeit with less quality and using less computational resources allowing the generative AI computing system to service more demands. In cases where demands are less complex, the number of demands does not exceed the threshold number, or the rate of demands does not exceed the threshold rate, orchestration engine 232 may configure one or more generative AI models 236 by tuning the models to utilize more computational resources to produce higher quality generated content to take advantage of the availability of computing resources.

In block 408, orchestration engine 232 is capable of dynamically adapting content. In one or more embodiments, orchestration engine 232 includes one or more AI models and/or rule-based systems configured to evaluate demands 212 and adjust the demands 212 (e.g., modify one or more of the demands) to vary the content generation process in near-real time. This dynamic adaptation of demands 212 ensures that the generated content remains engaging, relevant, and tailored to the collective needs of users 206.

As an illustrative and non-limiting example, user engagement with generated content may be evaluated based on sentiment analysis of certain sensor data, information shared from the user's device (e.g., whether the user stopped or terminated the playing of generated content or provided explicit feedback indicating a level of satisfaction or dissatisfaction with the generated content received), and/or image processing performed on images of a user's face to detect gaze and whether the user is looking at generated content that has been provided or looking at a POI that may be the subject of generated content currently provided to the user. A user looking away from generated content played via a device, but looking at the subject of that content such as a POI may be interpreted as indicating interest in the generated content by the user rather than disinterest as if the user were looking away from the content and not looking at a POI that is the subject of the generated content. In the event that the sentiment analysis and/or gaze detection indicates a minimum level of disinterest by the user (e.g., low sentiment and/or looking away from the device and/or POI(s) for a minimum amount of time), orchestration engine 232 is capable of modifying the demand corresponding to the user to obtain different and/or updated generated content.

In block 410, orchestration engine 232 is capable of delivering content to users 206 (e.g., to devices 208 of users 206). For example, orchestration engine 232 is capable of receiving any content generated locally by generative AI models 236 and/or content obtained from remote systems and provide such content to the appropriate or correct users. Offloading engine 234, for example, is capable of distributing demands to the various systems. Orchestration engine 232 is capable of receiving the generated content and distributing the content to devices 208. In this regard, orchestration engine 232 is capable of routing generated content received from a plurality of different sources to the correct destination devices 208.

In block 412, orchestration engine 232 is capable of performing feedback-based, reinforced learning on AI models and/or rule-based systems that may implement blocks 402, 404, 406, and/or 408. For example, orchestration engine 232 is capable of implementing a continuous feedback loop that gathers information from user interactions and environmental feedback. Such information may include performance metrics such as user satisfaction and content relevance (e.g., as explicitly provided or inferred by orchestration engine 232 as previously discussed). The reinforced learning algorithms implemented by orchestration engine 232 are capable of comparing the resulting outcomes (e.g., user satisfaction and/or content relevance) and apply a rule-based and/or AI model-based technique to iteratively adjust and enhance the efficiency of the AI models and/or rule-based systems involved in dynamically adapting the generated content (e.g., by manipulation and/or generation of demands by orchestration engine 232). The reinforced learning algorithms of orchestration engine 232 are also capable of modifying the configuration(s) (e.g., tuning) of the AI models used in blocks 402, 404, and/or 406 based on the collected user feedback.

Though method 400 is illustrated as a series of serially performed blocks, it should be appreciated that the blocks of FIG. 4 may be performed continuously in real-time or near real-time such that the data generated is continuously being updated in real-time or near real-time.

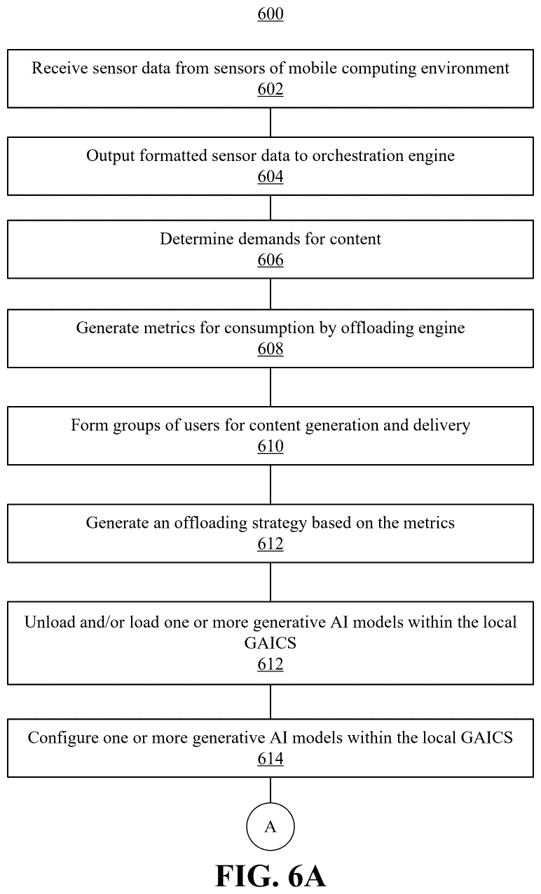

FIG. 5 illustrates a method 500 of certain operative features of offloading engine 234 in accordance with one or more embodiments of the disclosed technology. In block 502, offloading engine 234 is capable of generating an offloading strategy (e.g., a recommendation) specifying which of demands 212 to offload to one or more of computing nodes 220 and which are to be performed by local GAICS 204 using generative AI models 236. The offloading strategy specifics, for example, which ones of computing nodes 220 are to handle particular ones of demands 212 designated for offloading. In one or more embodiments, offloading engine 234 is capable of generating the offloading strategy based on the metrics obtained from orchestration engine 232, the demands, and/or context 224. Offloading engine 234 may include an AI model and/or rule-based system that, given the metrics described, is trained to generate an offloading strategy.

In generating the offloading strategy, offloading engine 234 is capable of matching particular demands to be offloaded to local GAICS 204 and/or to particular computing nodes 220. The demands also may be matched to particular generative AI models, whether local or remote. The matching may be performed based, at least in part, on the various metrics obtained from orchestration engine 232. As noted, these metrics may include, but are not limited to, the availability of the computing node 220 to generate content in response to a given demand (e.g., whether mobile computing environment 202 is within the geographic service area of the computing node 220), the availability of computing resources (e.g., hardware) to handle a given demand given the compute node's 220 current workload, the availability of a generative AI model capable of responding to the demand on compute node 220, whether the response to the demand may be received from the selected computing node 220 in a timely manner, location of mobile computing environment 202 relative to the compute node 220, the availability of computing resources (e.g., hardware) to handle a given demand given the current workload of local GAICS 204, the availability of a generative AI model capable of responding to the demand on local GAICS 204, information from context 224, variations in collective behavior to determine the necessity of offloading, and/or different combinations thereof. As noted, the matching of demands to compute nodes 220 and/or generative AI models also matches the modality of the content to be generated with the modality of the content that the generative AI model is intended to generate (demands for text to generative AI models trained to generate text, demands for audio to generative AI models trained to generate audio, demands for video and/or images to generative AI models trained to generate video and/or images, etc.)

Regarding whether the response to the demand is received from the selected computing node 220 in a timely manner, offloading engine 234 may account for a variety of different factors. These may include distance between mobile computing environment 202 and the selected computing node, congestion of the network to be used to connect local GAICS 204 with the selected computing node 220, whether, given the distance and network congestion and the current workload of the selected computing node, the response will be received within a minimum or threshold amount of time (e.g., in an amount of time to be perceived by the user as real-time or near real-time).

In one or more embodiments, the threshold amount of time may be calculated as an estimate of the time for mobile computing environment 202 to pass by a POI on route 214 given current speed and/or traffic and/or weather conditions. The POI in this example may be the subject of the demand being offloaded and for which generative content is being sought. If the response is not predicted to be received within a particular margin of the threshold, the demand may be provided to another computing node, queued for handling by local GAICS 204, or dropped in cases where the response is not adequately timed with the passing of the POI by the mobile computing environment 202.

In block 504, offloading engine 234 is capable of distributing demands 212 to one or more selected generative AI computing systems in accordance with the offloading schedule. Offloading engine 234, for example, is capable of offloading demands 212, if any, that have been selected for offloading to compute nodes 220 in accordance with the offloading strategy generated in block 502. As noted, the offloading strategy may account for various factors that may include, but are not limited to, timely processing of the demand(s) and compensating for any lack of local resources in local GAICS 204.

In block 506, offloading engine 234 is capable of implementing continuous monitoring and adaptation. The monitoring and adaptation assess the success of the offloading strategy. The success of the offloading strategy may be determined based on whether a response to a demand was received within the expected time (e.g., within the margin of the threshold). In one or more embodiments, offloading engine 234 is capable of receiving feedback from orchestration engine 232 and/or users 206 regarding timeliness of the generated content and/or other performance metrics to adapt and refine the offloading strategy over time. Offloading engine 234 is capable of implementing a reinforced learning algorithm in an iterative or continuous manner to adjust the offloading strategy generation performed to achieve improved results over current offloading outcomes.

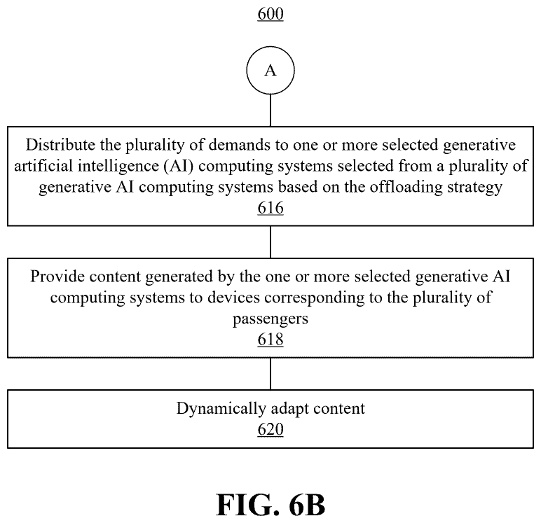

FIGS. 6A and 6B, taken collectively and collectively referred to as FIG. 6, illustrate a method 600 of certain operative features of local GAICS 204 in accordance with one or more embodiments of the disclosed technology. In the example of FIG. 6, method 600 may be performed in the context of mobile computing environment 202 moving along route 214 with a known context 224.

In block 602, the sensor data processor 230 is capable of receiving sensor data from sensors 210. In one or more embodiments, any data shared by users via their respective devices such as content consumption, explicit feedback, etc., also may be collected by sensor data processor 230. In block 604, sensor data processor 230 is capable of outputting formatted sensor data to orchestration engine 232. The sensor data as formatted, may include formatted data shared by users as described.

In block 606, orchestration engine 232 is capable of determining a plurality of demands for content. Orchestration engine 232 can determine the demands for content based, at least in part, on a context of mobile computing environment 202, and sensor data for mobile computing environment 202 and for a plurality of users within mobile computing environment 202. In one or more examples, orchestration engine 232 is capable of automatically generating the one or more of the plurality of demands based, at least in part, on a point of interest along a route specified by the context of the mobile computing environment. For example, one or more of the demands, as automatically generated, may request content relating to POI 218 or another POI on route 214 such as destination 216. In one or more embodiments, orchestration engine 232 is capable of receiving one or more of the plurality of demands from one or more of the plurality of users (e.g., explicitly).

In block 608, orchestration engine 232 is capable of generating metrics based, at least in part, on a plurality of demands for content, context 224 of mobile computing environment 202, sensor data for mobile computing environment 202 and users 206 within the mobile computing environment 202, and operating states of a plurality of generative artificial intelligence (AI) computing systems. The metrics, as generated by orchestration engine 232, are provided to offloading engine 234 for use in generating the offloading strategy. The metrics may be generated as described in connection with FIG. 4.

In block 610, optionally, groups of users may be formed or created. In one or more embodiments, orchestration engine 232 is capable of forming a plurality of groups of the plurality of users 206. In that case, one or more of the selected generative AI systems are selected on a per group basis for generating content for the selected groups. That is, rather than generating content to fulfill demands on a per user basis, groups of users may be formed and content may be generated for the group as a collection of two or more users (e.g., on a per-group basis).

As an illustrative and nonlimiting example, consider the case where sensor data for the users includes facial feature recognition data that is provided to an AI model trained for performing mood analysis, heartbeat data for users is available as sensor data, and whether the users (e.g., individually) are attentive to content being provided based on gaze detection, audio from conversations (e.g., by processing audio through a speech recognition engine and the recognized text through a natural language understanding model), or the like. Orchestration engine 232 is capable of executing any of a variety of grouping techniques such as regression, clustering (e.g., KNN clustering), or the like to form groups of like users. Each group may include users demonstrating particular traits or behaviors or a particular percentage of such traits or behaviors.

In another example, groups of users may be generated by performing the regression, clustering, and/or other grouping techniques on demands. Those demands considered similar, e.g., within a threshold similarity using a distance metric, for example, may be grouped together. The users to which each demand corresponds (whether received from the users or the demands were generated automatically on behalf of the user or both) may be placed in a same group.

Whether the groups are formed based on the demands and/or user traits, orchestration engine 232 may generate a demand that is representative of the plurality of demands in the group or corresponding to members of the group. Orchestration engine 232 may replace the plurality of demands corresponding to members of the group with the representative demand. This reduces the computational load of generating content since one demand, e.g., the representative demand, may be processed in place of the plurality of demands of the group to serve a plurality of users. Content generated in response to the representative demand may be provided to the users in the group.

In some embodiments, orchestration engine 232 is capable of predicting the content to be generated for a selected group of the plurality of groups based on context 224 and the metrics generated. In one or more alternative embodiments, content may be predicted based on a group context that defines common traits or behaviors of users in the selected group. With content predicted based on the aforementioned factors, orchestration engine 232 is capable of generating or creating demands for the predicted content that may be handled or processed as any other demands described herein.

In generating content for the group, local GAICS 204 effectively groups users with like interest and/or profiles and provides the same content to each member of the group. It also should be appreciated that predictions of content may be performed for individual users also.

In the example of FIG. 6, though certain operations are illustrated as being performed serially, in other examples, such operations may be performed iteratively and include feedback. For example, as metrics are continually generated, such metrics may be used as input to generate further demands and/or update demands, which then are evaluated for further metric generation.

In block 612, offloading engine 234 is capable of generating an offloading strategy based on one or more of the metrics generated by orchestration engine 232. The offloading strategy defines, or specifies, which demands of the plurality of demands are to be performed by different ones of the plurality of generative AI computing systems (e.g., local GAICS 204 and/or computing nodes 220). In this regard, the orchestration strategy dictates which demands are to be offloaded to one or more of computing nodes 220 and which demands are to be handled by local GAICS 204.

For purposes of illustration, consider an example where the plurality of generative AI computing systems includes a first generative AI computing system local to mobile computing environment 202 (e.g., local GAICS 204) and a second or more generative AI computing system(s) such as computing nodes 220 remotely located from mobile computing environment 202. In one or more embodiments, the offloading strategy is generated based, at least in part, on a distance between the second generative AI computing systems and mobile computing environment 202 where generative AI computing systems closer to mobile computing environment 202 may be favored or selected over generative AI computing systems farther from mobile computing environment 202 so long as such generative AI computing systems have the computing resources, generative AI models, and/or are otherwise available to handle the demands.

In one or more embodiments, the offloading strategy is generated based, at least in part, on estimated response time, e.g., timeliness as discussed below, for receiving content from the second generative AI computing system. In this regard, the estimated time of receipt of content from the second generative AI computing system must be prior to a required time as previously discussed. In one or more embodiments, the offloading strategy is generated based, at least in part, on available computing capacity of the first generative AI computing system and an availability of one or more generative AI models on the first generative AI computing system required for generating content in response to the plurality of demands.

With respect to timeliness, for example, offloading engine 234 is capable of making a decision whether a selected generative AI computing system to which local GAICS 204 is not currently connected, but to which local GAICS 204 will be connected in an estimated amount of time given route 214 and the metrics, will be capable of generating content for a demand within established time constraints. For example, mobile computing environment 202 may not yet be connected to mobile node 220-2, but determines that mobile computing environment 202 will be connected to mobile node 220-2 shortly within a predetermined amount of time.

In response to offloading engine 234 determining that the selected computing node will be able to meet the time constraints (e.g., providing generated content to the device of the user within a given period of time or concurrently with or prior to passing a POI that is the subject of the generated content), offloading engine 234 may generate the offloading strategy to specify that the particular demand being considered is to be delayed for a specified amount of time and submitted at the expiration of that specified amount of time when offloading engine 234 estimates mobile computing environment 202 to be in the service area or range of the selected computing node 220. In one or more embodiments, the offloading strategy is generated based on estimated response time for receiving content from the generative AI computing systems (e.g., selecting generative AI computing systems to service particular demands that are estimated to provide the lowest response time so long as such generative AI computing systems have the computing resources, generative AI models, and/or are otherwise available to handle the demands).

In another example, offloading engine 234 is capable of generating an offloading strategy that will schedule demands for content relating to destination 216 to be offloaded to computing node 220-2 as opposed to compute node 220-1 given the time needed to traverse route 214 and the proximity of computing node 220-2 to destination 216. Demands relating to POI 218 may be directed to computing node 220-1 so that the generated content is available prior to mobile computing environment 202 reaching POI 218 rather than providing such demands to computing node 220-3 or computing node 220-2.

In block 612, orchestration engine 232 is capable of unloading and/or loading one or more generative AI models within local GAICS 204. In one or more embodiments, the unloading and/or loading is performed in response to one or more of the demands and/or the metrics. In one or more embodiments, the unloading and/or loading is performed in response to one or more of the demands to be serviced locally per the offloading strategy. For example, in cases where a generative AI model is needed that is not currently loaded, orchestration engine 232 is capable of loading such generative AI model to service one or more demand(s) based on the offloading strategy. In response to determining that there are insufficient computing resources to load the generative AI model, orchestration engine 232 is capable of unloading a different generative AI model that is not required to service demands to be serviced locally by local GAICS 204.

In one or more embodiments, orchestration engine 232 is capable of loading and/or unloading one or more of the generative AI models 236 based on route 214 and any known POIs along route 214. For example, orchestration engine 232 is capable of predicting content that may be desired by users 206 based on route 214 and POIs along the route and load and/or configure generative AI model(s) 236 that are suited for generating the type of content predicted in anticipation and preparation for meeting expected demands from users 206.

In block 614, orchestration engine 232 is capable of configuring one or more of the generative AI models 236. In one or more embodiments, the configuring (e.g., tuning) is performed based on one or more of the demands. In one or more embodiments, the configuring is performed based on one or more of the demands to be serviced locally per the offloading strategy. In some embodiments, the tuning may account for user and/or group preferences from which the demand(s) to be serviced by the generative AI model being tuned originated.

In block 616, the demands 212 are distributed to one or more selected generative AI computing systems selected from the plurality of generative AI computing systems based on the offloading strategy. In one or more embodiments, the distribution of demands may be performed by offloading engine 234, which is capable of providing demands to be handled locally to one or more of generative AI models 236 and providing demands to one or more selected computing nodes 220. Appreciably, in some cases, demands 212 need not be offloaded at all and the number of demands offloaded may vary over time. In some cases, certain demands that may not be serviced in a timely manner or for which insufficient computing resources (e.g., whether hardware or the lack of a suitable generative AI model) may be dropped. In such cases, the demands may be specified as non-deliverable by the offloading schedule and simply purged.

In block 618, content generated by the one or more selected generative AI computing systems is provided to devices corresponding to users 206. In one or more embodiments, content received in response to demands, whether submitted to generative AI models 236 and/or to one or more of computing nodes 220, may be received by orchestration engine 232, which may then coordinate the delivery of content as generated from multiple sources such as one or more of computing nodes 220 and/or local GAICS 204 to the appropriate or correct devices 208.

In block 620, optionally, local GAICS 204 is capable of dynamically adapting content provided to users. In one or more embodiments, orchestration engine 232 is capable of adjusting demands (e.g., modifying requests for content) in response to detecting certain conditions in the sensor data and/or user data. For example, orchestration engine 232 is capable of modifying a demand in response to detecting that the user is not engaging or paying attention to content being delivered, modifying a demand in response to changing proximity of mobile computing environment 202 to a POI (e.g., getting within a predetermined range of the POI such that the demand is modified to request information about the POI), and/or generate a new demand for content that may be provided to the user/device in place of content orchestration engine 232 determines the user is not interested in.

In another example, consider a case in which a first group of users, based on sensor data and/or user feedback, are bored or tired of the content currently being delivered. For example, based on image data from a camera, sensor data processor 230 generates context data indicating that the users are looking away from generated content as provided via one or more devices or are looking outside of mobile computing environment 202 (but not at a POI that is the subject of the generated content). Based on the sensor data and optionally user provided data or feedback, orchestration engine 232 determines that mobile computing environment 202 is approaching a POI (e.g., a landmark) and modifies or creates demands to request content relating to the POI. In one or more embodiments, the demand, which may be a script to be provided as input (e.g., a prompt) to a generative AI model, being created by orchestration engine 232, may be cached for future use in response to same or similar contextual situations for mobile computing environment 202.

Concurrently, for those users that are interested in the content currently being played, orchestration engine 232 may generate a different demand that results in generation of different content such as a teaser (e.g., shorter length content that may be played after the current content or more easily inserted into the currently playing content).

In one or more embodiments, the weighting or importance of different types of sensor data (e.g., the data obtained from particular sensors 210) may be elevated based on the context 224, sensor data, and/or metrics. As an illustrative and nonlimiting example, in the case where mobile computing environment 202 is an airplane, a temperature sensor may indicate an internal cabin temperature that is higher than a threshold temperature as the plane is grounded or has not taken off as expected. In that case, the higher-than-normal temperature may be prioritized, or given greater weight, in content generation to alleviate discontent among users. In this manner, content generation may be adapted to current and/or changing sensor data with the importance of different sensor data also being adapted based on current readings. The elevation of particular sensor data over other sensor data may result in changing demands or an adaptation in the way that demands are modified.

The terminology used herein is for the purpose of describing particular embodiments only and is not intended to be limiting. Notwithstanding, several definitions that apply throughout this document now will be presented.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without intervention from a human being. The term “user” refers to a human being. A passenger is an example of a user.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “hardware processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processor set 110 is an example of a hardware processor. A hardware processor is an example of computer hardware.

As defined herein, the term “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
generating metrics based, at least in part, on a plurality of demands for content, a context of a mobile computing environment, sensor data for the mobile computing environment and a plurality of users within the mobile computing environment, and operating states of a plurality of generative artificial intelligence (AI) computing systems;
generating an offloading strategy defining which demands of the plurality of demands are to be performed by different ones of the plurality of generative AI computing systems based on the metrics;
distributing the plurality of demands to one or more selected generative AI computing systems selected from the plurality of generative AI computing systems based on the offloading strategy; and
providing content generated by the one or more selected generative AI computing systems to devices corresponding to the plurality of users.

2. The method of claim 1, further comprising:
receiving one or more of the plurality of demands from one or more of the plurality of users.

3. The method of claim 1, further comprising:
automatically generating one or more of the plurality of demands based, at least in part, on the context of the mobile computing environment and the sensor data.

4. The method of claim 3, wherein the automatically generating the one or more of the plurality of demands is based, at least in part, on a point of interest along a route of the mobile computing environment.

5. The method of claim 1, wherein the mobile computing environment is a vehicle.

6. The method of claim 5, wherein the vehicle is in motion along a predetermined route.

7. The method of claim 1, wherein the plurality of generative AI computing systems includes a first generative AI computing system local to the mobile computing environment and a second generative AI computing system that is remotely located from the mobile computing environment.

8. The method of claim 7, wherein the offloading strategy is generated based, at least in part, on a distance between the second generative AI computing systems and the mobile computing environment.

9. The method of claim 7, wherein the offloading strategy is generated based, at least in part, on an estimated response time for receiving content from the second generative AI computing system.

10. The method of claim 7, wherein the offloading strategy is generated based, at least in part, on available computing capacity of the first generative AI computing system and an availability of one or more generative AI models on the first generative AI computing system required for generating content in response to one or more of the plurality of demands.

11. The method of claim 7, further comprising:
unloading an AI model from the first generative AI computing system and loading a different AI model in the first generative AI computing system based on one or more of the plurality of demands.

12. The method of claim 7, further comprising:
configuring an AI model executed by the first generative AI computing system based on one or more of the plurality of demands.

13. A system, comprising:
a hardware processor capable of executing operations including:
generating metrics based, at least in part, on a plurality of demands for content, a context of a mobile computing environment, sensor data for the mobile computing environment and a plurality of users within the mobile computing environment, and operating states of a plurality of generative artificial intelligence (AI) computing systems;
generating an offloading strategy defining which demands of the plurality of demands are to be performed by different ones of the plurality of generative AI computing systems based on the metrics;
distributing the plurality of demands to one or more selected generative AI computing systems selected from the plurality of generative AI computing systems based on the offloading strategy; and
providing content generated by the one or more selected generative AI computing systems to devices corresponding to the plurality of users.

14. The system of claim 13, wherein the plurality of generative AI computing systems includes a first generative AI computing system local to the mobile computing environment and a second generative AI computing system that is remotely located from the mobile computing environment.

15. The system of claim 14, wherein the offloading strategy is generated based, at least in part, on a distance between the second generative AI computing systems and the mobile computing environment.

16. The system of claim 14, wherein the offloading strategy is generated based, at least in part, on an estimated response time for receiving content from the second generative AI computing system.

17. The system of claim 14, wherein the offloading strategy is generated based, at least in part, on available computing capacity of the first generative AI computing system and an availability of one or more generative AI models on the first generative AI computing system required for generating content in response to the plurality of demands.

18. The system of claim 14, wherein the processor capable of executing operations further comprising:
unloading an AI model from the first generative AI computing system and loading a different AI model in the first generative AI computing system based on one or more of the plurality of demands.

19. The system of claim 14, wherein the processor capable of executing operations further comprising:
configuring an AI model executed by the first generative AI computing system based one or more of the plurality of demands.

20. A computer program product comprising one or more computer readable storage mediums having program instructions embodied therewith, wherein the program instructions are executable by a hardware processor to cause the hardware processor to execute operations comprising:
generating metrics based, at least in part, on a plurality of demands for content, a context of a mobile computing environment, sensor data for the mobile computing environment and a plurality of users within the mobile computing environment, and operating states of a plurality of generative artificial intelligence (AI) computing systems;
generating an offloading strategy defining which demands of the plurality of demands are to be performed by different ones of the plurality of generative AI computing systems based on the metrics;
distributing the plurality of demands to one or more selected generative AI computing systems selected from the plurality of generative AI computing systems based on the offloading strategy; and
providing content generated by the one or more selected generative AI computing systems to devices corresponding to the plurality of users.
